(19) United States
(12) Patent Application Publication
(10) Pub. No.: US 2009/0319637 A1
(43) Pub. Date: Dec. 24, 2009

(54) COMPUTER SYSTEM AND METHOD FOR ACCESSING SYSTEM INFORMATION OF THE COMPUTER SYSTEM

(75) Inventors: ZHEN WANG, Shenzhen City (CN); SHUN-YUAN SHI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (TW); HON HAI PRECISION INDUSTRY CO., LTD., Tu-Cheng (TW)

(21) Appl. No.: 12/327,616

(22) Filed: Dec. 3, 2008

(30) Foreign Application Priority Data
Jun. 18, 2008 (CN) 200810302187.5

(51) Int. Cl. G06F 15/16; G06F 15/177

(52) U.S. Cl. 709/219; 713/2

(57) ABSTRACT

A computer system includes a GPNV ram, an IPMI module, and a BIOS module. The IPMI module includes a BMC configured to monitors states of the computer system. The BMC includes an FRU. The BIOS module is configured to read system information of the computer system when the computer system is switched on, and copy the system information to the FRU of the IPMI module from the GPNV ram. A method for accessing the system information of the computer system is also provided.

### BACKGROUND

1. Technical Field

The present disclosure relates to a computer system and a method allowing remote access to its system information.

2. Description of the Related Art

System information of a typical computer system is stored in a general purpose non-volatile (GPNV) ram. If a user wants to access the system information, the computer system must be started and a special program executed to display the system information. However, the system information cannot be accessed when the computer system is off. In addition, since the system information is stored in GPNV ram, the system information cannot be remotely accessed via a network terminal.

Therefore, there is room for improvement within the art.

### BRIEF DESCRIPTION OF THE DRAWINGS

FIG. 1 is a block diagram of an embodiment of a computer system.

FIG. 2 is a flow chart illustrating an embodiment of a method for remotely accessing system information of the computer system of FIG. 1.

### DETAILED DESCRIPTION OF THE EMBODIMENTS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

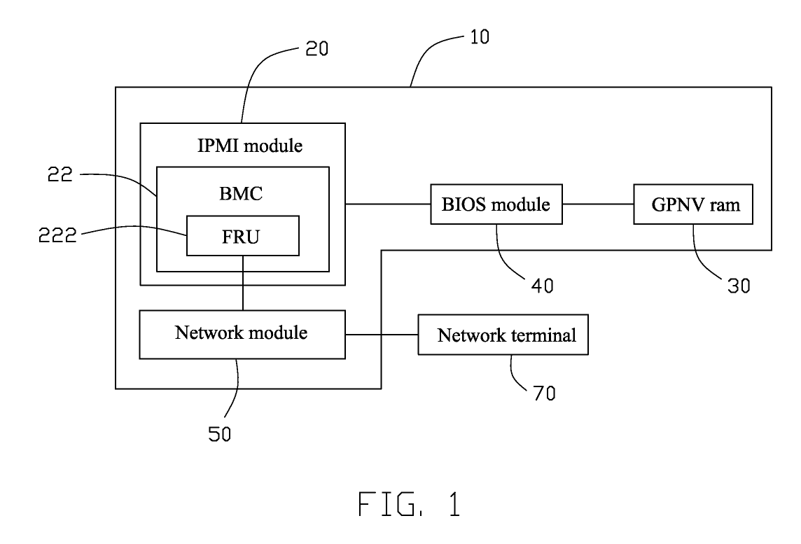

Referring to FIG. 1, an embodiment of a computer system 10 is configured to communicate with a remote network terminal 70. The computer system 10 includes a general purpose non-volatile (GPNV) ram 30, an intelligent platform management interface (IPMI) module 20, a basic input output system (BIOS) module 40, and a network module 50.

The GPNV ram 30 can be used to store system information of the computer system 10. The system information includes information of the BIOS, memory, cache, processor, and other information defined in a system management BIOS (SMBIOS). The IPMI module 20 includes a baseboard management controller (BMC) 22. The BMC 22 monitors states of the computer system 10, for example, temperatures of processors, velocities of fans, and so on. The BMC 22 includes a field replaceable unit (FRU) 222 having a serial electronically erasable programmable read-only memory (SEEPROM) for storing data information. The network module 50 communicates with the network terminal 70 via a network connection, and the FRU 222 can be accessed by the network module 50.

The BIOS module 40 reads the system information when the computer system 10 is started, and saves the system information in the GPNV ram 30. In addition, the BIOS module 40 copies the system information of the computer system 10 from the GPNV ram 30 to the FRU 222.

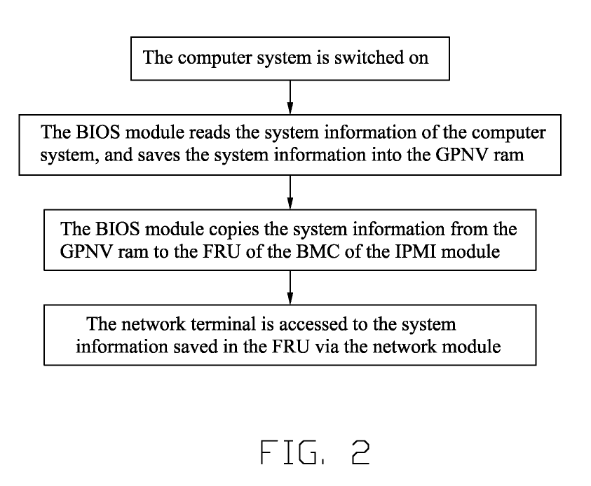

Referring also to FIG. 2, when the computer system 10 is switched on, the BIOS module 40 reads the system information of the computer system 10, and saves the system information into the GPNV ram 30. The BIOS module 40 then copies the system information from the GPNV ram 30 to the FRU 222. The network terminal 70 has access to the system information saved in the FRU 222 via the network module 50 to allow remote access to the system information.

In one embodiment, the system information of the computer system 10 is not only saved in the GPNV ram 30, but also saved in the FRU 222. The network terminal 70 is capable of accessing the system information of the computer system 10 stored in the FRU 222, because the FRU 222 can be accessed by the network module 50.

In addition, the computer system 10 and the IPMI module 20 are electrically connected to a common power supply (not shown). However, the IPMI module 20 can remain on when the computer system 10 is switched off, thereby allowing access to the system information anytime from the network terminal 70.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer system, comprising:
a general purpose non-volatile (GPNV) ram;
an intelligent platform management interface (IPMI) module comprising a baseboard management controller (BMC) is configured to monitors states of the computer system, the BMC comprising a field replaceable unit (FRU); and
a basic input output system (BIOS) module, wherein the BIOS module is configured to read system information of the computer system when the computer system is switched on, and to copy the system information to the FRU of the IPMI module from the GPNV ram.

2. The computer system of claim 1, wherein the FRU has a serial electronically erasable programmable read-only memory for storing the system information.

3. The computer system of claim 1, wherein the IPMI module remains on when the computer system is switched off.

4. The computer system of claim 1, further comprising a network module configured to access the FRU, wherein the network module communicates with a network terminal with a network connection; the FRU is accessible by the network terminal via the network module.

5. A computer system, comprising:
an intelligent platform management interface (IPMI) module comprising a baseboard management controller (BMC) is configured to monitors states of the computer system, the BMC comprising a field replaceable unit (FRU) for storing system information of the computer system; and
a network module accessible to the FRU, wherein the network module communicates with a network terminal with a network connection; the network terminal can access the system information of the computer system of the FRU via the network module.

6. The computer system of claim 5, further comprising a general purpose non-volatile (GPNV) ram for storing the system information.

7. The computer system of claim 6, further comprising a basic input output system (BIOS) module, wherein the BIOS is configured to read system information of the computer system when the computer system is switched on, and to copy the system information to the FRU of the IPMI module from the GPNV ram.

8. The computer system of claim 5, wherein the FRU has a serial electronically erasable programmable read-only memory for storing the system information.

9. The computer system of claim 5, wherein the IPMI module remains on when the computer system is switched off.

10. A method for accessing system information of a computer system by a network terminal, the method comprising:
storing the system information to a general purpose non-volatile (GPNV) ram by a basic input output system (BIOS) module;
copying the system information from the GPNV ram to a field replaceable unit (FRU) of a baseboard management controller of an intelligent platform management interface (IPMI) module by the BIOS module; and
accessing the system information in the FRU by the network terminal via a network module.

11. The method of claim 10, wherein the FRU has a serial electronically erasable programmable read-only memory for storing the system information.

12. The method of claim 10, wherein the IPMI module remains on when the computer system is switched off.
